(19) United States
(12) Patent Application Publication
(10) Pub. No.: US 2024/0347232 A1
(43) Pub. Date: Oct. 17, 2024

(54) METHOD FOR MANUFACTURING WIRE HARNESS

(71) Applicant: YAZAKI CORPORATION, Tokyo (JP)

(72) Inventors: Itsuki Hasegawa, Makinohara-shi (JP); Jin Watanabe, Makinohara-shi (JP)

(21) Appl. No.: 18/625,211

(22) Filed: Apr. 3, 2024

(30) Foreign Application Priority Data
Apr. 13, 2023 (JP) 2023-065453

(51) Int. Cl. H01B 13/012

(52) U.S. Cl. CPC H01B 13/01209

(57) ABSTRACT

A method for manufacturing a wire harness includes a harness assembling process, a mold release member installing process of, when a plurality of wire harnesses are assembled, each time the harness assembling process is ended, placing a mold release member on a wire harness, and a joining process of joining components of the wire harness together for each wire harness. The harness assembling process includes a first outer layer installing process of installing an exterior member as one outer layer on a jig plate, an inner layer installing process of routing a protection target part of at least one routed electric wire to the exterior member as the one outer layer, and a second outer layer installing process of overlaying an exterior member as another outer layer on the protection target part and the exterior member.

### CROSS-REFERENCE TO RELATED APPLICATION(S)

The present application claims priority to and incorporates by reference the entire contents of Japanese Patent Application No. 2023-065453 filed in Japan on Apr. 13, 2023.

### BACKGROUND OF THE INVENTION

### 1. Field of the Invention

The present invention relates to a method for manufacturing a wire harness.

### 2. Description of the Related Art

In a wire harness, its electric wires are routed by being, for example, caused to follow structures such as a vehicle body and a powertrain. Thus, in this wire harness, adhesive tape wound around the electric wires and corrugated tubes housing the electric wires are being used as exterior members to protect the electric wires from, for example, interference with surrounding components. The related technologies are described, for example, in: Japanese Patent Application Laid-open No. H11-241790 A, and Japanese Patent Application Laid-open No. 2020-10453 A.

In conventional wire harnesses, exterior members are assembled to electric wires by, for example, winding adhesive tape around the electric wires or inserting the electric wires into corrugated tubes. Given these circumstances, in conventional wire harnesses, especially when routing paths for the electric wires are complicated or the electric wires are branched, it is necessary to manually assemble the exterior members to the electric wires in order to secure the quality after assembly. Thus, conventional wire harnesses have room to reduce costs in their manufacturing processes.

### SUMMARY OF THE INVENTION

Thus, an object of the present invention is to provide a method for manufacturing a wire harness that can reduce costs.

In order to achieve the above mentioned object, in a method for manufacturing a wire harness according to one aspect of the present invention, the method includes a harness assembling process of assembling a wire harness; a mold release member installing process of, when a plurality of the wire harnesses are assembled, each time the harness assembling process is ended, placing a mold release member capable of preventing the wire harnesses adjacent to each other from sticking to each other on the wire harness for which the harness assembling process has been ended; and a joining process of joining components of the wire harness to each other for each wire harness, wherein the harness assembling process includes: a first outer layer installing process of installing, among a plurality of mesh-like and sheet-like exterior members provided with insulation on outer surfaces, the exterior member as one outer layer on a jig plate; an inner layer installing process of routing a protection target part of at least one routed electric wire to the exterior member as the one outer layer; and a second outer layer installing process of overlaying the exterior member as another outer layer among the exterior members on the protection target part and the exterior member on which the protection target part has been placed, and at the joining process, the exterior members of the wire harness are joined together for each wire harness.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a plan view of a wire harness according to an embodiment;

FIG. 2 is an exploded perspective view of the wire harness according to the embodiment;

FIG. 3 is a perspective view of a jig plate according to the embodiment;

FIG. 4 is an illustrative diagram illustrating a first outer layer installing process for a first set according to the embodiment;

FIG. 5 is an illustrative diagram illustrating an inner layer installing process (an electric wire installing process) for the first set according to the embodiment;

FIG. 6 is an illustrative diagram illustrating a second outer layer installing process for the first set according to the embodiment;

FIG. 7 is an illustrative diagram illustrating a mold release member installing process according to the embodiment;

FIG. 8 is an illustrative diagram illustrating a first outer layer installing process for a second set according to the embodiment;

FIG. 9 is an illustrative diagram illustrating an inner layer installing process (an electric wire installing process) for the second set according to the embodiment;

FIG. 10 is an illustrative diagram illustrating a second outer layer installing process for the second set according to the embodiment;

FIG. 11 is an illustrative diagram illustrating the second outer layer installing process for the second set according to the embodiment;

FIG. 12 is an illustrative diagram illustrating a joining process according to the embodiment; and

FIG. 13 is an exploded perspective view of a modified mode of the wire harness according to the embodiment.

### DETAILED DESCRIPTION OF THE PREFERRED EMBODIMENTS

The following describes an embodiment of a method for manufacturing a wire harness according to the present invention in detail based on the accompanying drawings. This embodiment does not limit this invention.

### Embodiment

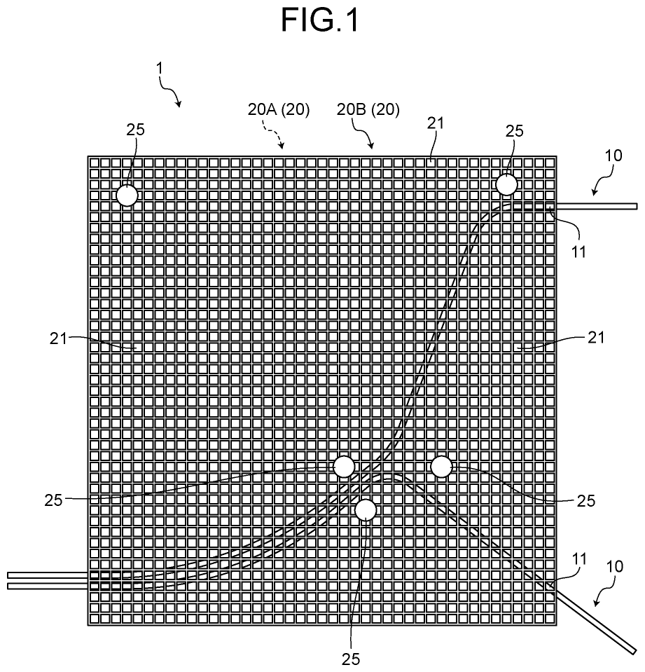

The following describes one embodiment of the method for manufacturing a wire harness according to the present invention based on FIG. 1 to FIG. 13.

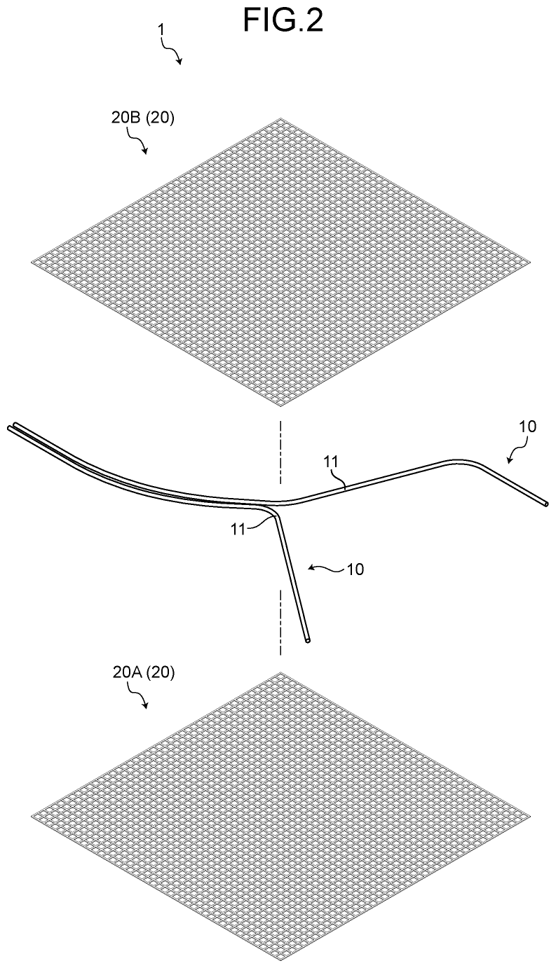

The symbol 1 in FIG. 1 and FIG. 2 indicates a wire harness assembled by the method of manufacture according to the present embodiment. This wire harness 1 has a part 11 to be protected of at least one routed electric wire 10 held between a pair of sheet-like exterior members 20 as a minimum configuration (FIG. 1 and FIG. 2). This wire harness 1 includes a plurality of mesh-like and sheet-like exterior members 20 provided with insulation on their outer surfaces and the at least one routed electric wire 10 the part 11 to be protected of which is held between the pair of exterior members 20 overlaid on each other.

The routed electric wire 10 refers to one electric wire or an electric wire bundle in which a plurality of electric wires are bundled. This routed electric wire 10 is routed by being, for example, caused to follow structures such as a vehicle body and a powertrain. Thus, in this routed electric wire 10, the place in which interference or the like with surrounding components is estimated is set to be the part 11 to be protected, and this part 11 to be protected is surrounded by the exterior members 20 to be protected from the outside.

The exterior members 20 are sheet-like members molded in a mesh shape and are provided with flexibility so as to be able to become deformed to, for example, follow the shape of the routed electric wire 10 held therebetween. These exterior members 20 are molded of, for example, an insulating material such as synthetic rubber in order to provide their outer surfaces with insulation while providing the entire with flexibility.

These exterior members 20 are desirably molded of an insulating material having a high friction coefficient of its outer surface in order to prevent the routed electric wire 10 held therebetween from being misaligned.

These exterior members 20 may include thereinside metallic elemental wires like reinforcing threads in order to hold their shape after deformation. For example, in these exterior members 20, the elemental wires may be incorporated in a mesh form, and a mesh-like insulating part may be formed of an insulating material such as synthetic rubber so as to follow the meshes of this mesh-like shape holding member. The mesh-like shape holding member can also be functioned as a shield member like what is called braid. Thus, these exterior members 20 can prevent, for example, noise from the outside entering simply by holding the routed electric wire 10 between the pair of exterior members 20 without separately surrounding the routed electric wire 10 with braid.

The exterior members 20 are stacked on each other, and the part 11 to be protected of the routed electric wire 10 is held between the pair of exterior members 20. These exterior members 20 have joints 25 in which at least parts thereof are joined together (FIG. 1). All the exterior members 20 may be the same member or all or part of them may be different members, for example, with different shapes and raw materials. In this example, the same, rectangular exterior members 20 are used for all of them.

In other words, this wire harness 1 has a layer structure including an exterior member 20A as one outer layer and an exterior member 20B as another outer layer and including the routed electric wire 10 the part 11 to be protected of which is held between the exterior member 20A as the one outer layer and the exterior member 20B as the other outer layer as a minimum configuration (FIG. 1 and FIG. 2). That is, this wire harness 1 has only one layer in which the part 11 to be protected is disposed (hereinafter, referred to as an “electric wire layer”) as a minimum configuration. This wire harness 1 can also be provided with a plurality of electric wire layers between the exterior member 20A as the one outer layer and the exterior member 20B as the other outer layer.

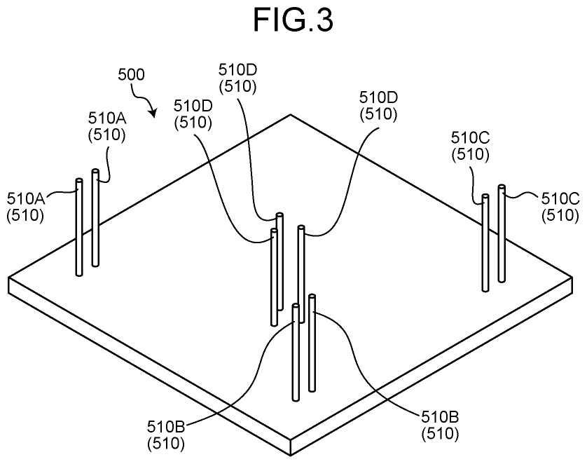

This wire harness 1 is assembled on a jig plate 500 (FIG. 3 to FIG. 10). The following describes a method of manufacture that can successively assemble a plurality of wire harnesses 1 on the jig plate 500.

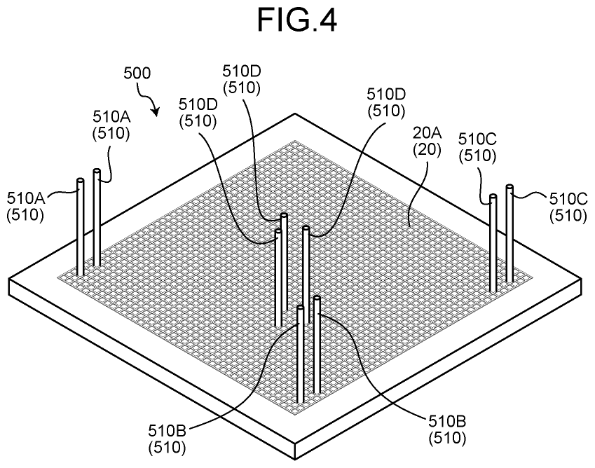

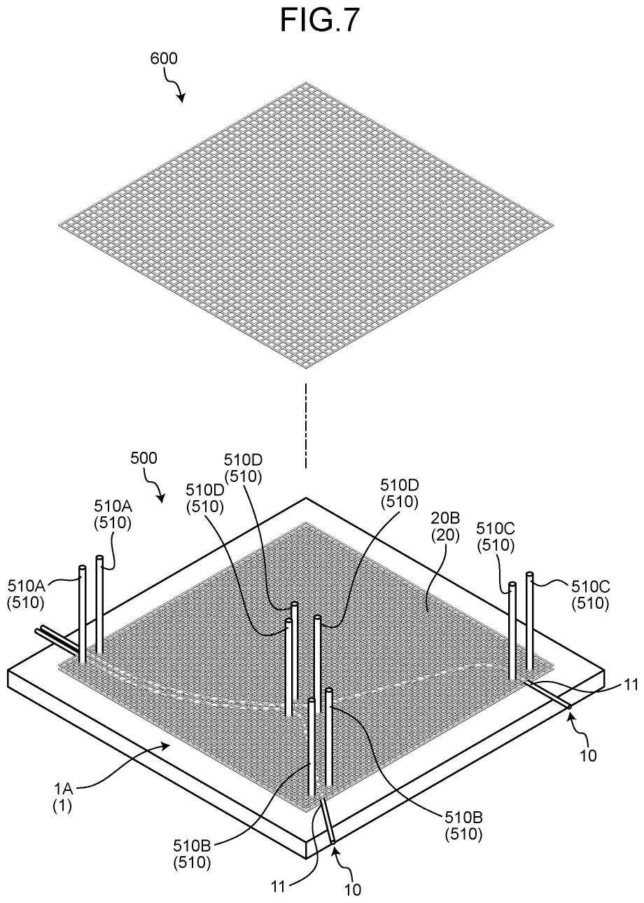

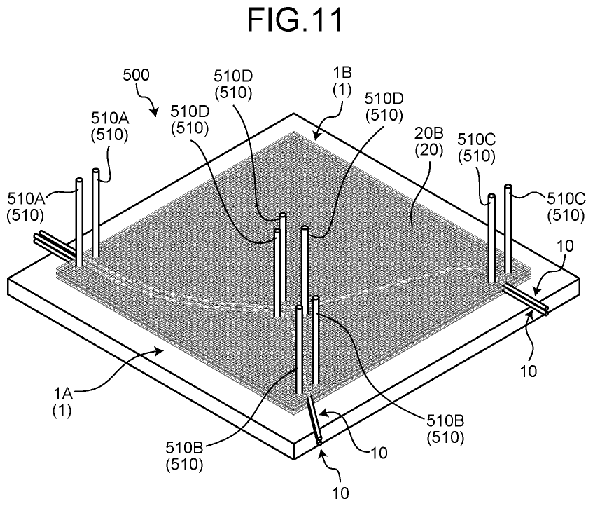

This method of manufacture includes a harness assembling process of assembling the wire harness 1 (FIG. 4 to FIG. 6 and FIG. 8 to FIG. 10), a mold release member installing process of, when a plurality of wire harnesses 1 are assembled, each time the harness assembling process is ended, placing a mold release member 600 capable of preventing the wire harnesses 1 adjacent to each other from sticking to each other on the wire harness 1 for which the harness assembling process has been ended (FIG. 7), and a joining process of joining components of the wire harness 1 together for each wire harness 1 (FIG. 11). The joining process may be performed each time the harness assembling process is ended or performed collectively for all the wire harnesses 1 after the harness assembling process for all the wire harnesses 1 is ended. Here, the joining process is performed after the harness assembling process for all the wire harnesses 1 is ended.

The harness assembling process includes a first outer layer installing process, an inner layer installing process, and a second outer layer installing process.

The following first describes the harness assembling process when one electric wire layer is disposed between the exterior member 20A as the one outer layer and the exterior member 20B as the other outer layer.

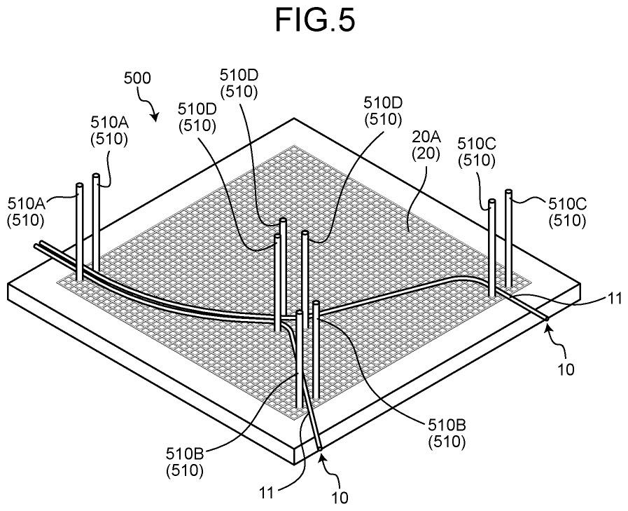

At the first outer layer installing process, the exterior member 20A as the one outer layer among the exterior members 20 is installed on the jig plate 500 (FIG. 4). Then, at the inner layer installing process, the part 11 to be protected of the at least one routed electric wire 10 is routed to the exterior member 20A as the one outer layer (FIG. 5).

At the inner layer installing process, when the part 11 to be protected is routed, the part 11 to be protected is passed through a gap between two electric wire routing pins 510 disposed along a routing path for the part 11 to be protected on the jig plate 500 (FIG. 5). In the jig plate 500, a set of at least two electric wire routing pins 510 are erected at a plurality of places along the routing path for the part 11 to be protected (FIG. 3 to FIG. 10). For example, a set of at least two electric wire routing pins 510 are disposed at, for example, a place as a bending point of the part 11 to be protected so as to follow the routing path for the part 11 to be protected.

When the exterior member 20A as the one outer layer is installed at the first outer layer installing process, if the electric wire routing pins 510 are not present immediately below the exterior member 20A, they do not interfere with installation work for this exterior member 20A. However, depending on the routing path for the part 11 to be protected, when the exterior member 20A as the one outer layer is installed at the first outer layer installing process, the electric wire routing pins 510 may be present immediately below the exterior member 20A. This example exemplified here shows this situation (FIG. 4). Thus, at the first outer layer installing process, when the exterior member 20A as the one outer layer is installed, the electric wire routing pins 510 thicker than mesh through holes 21 of this exterior member 20A (FIG. 1) are inserted into the mesh through holes 21.

In this wire harness 1, the exterior member 20 is formed in a mesh shape, and thus by utilizing the mesh through holes 21, the exterior member 20 can be installed on the jig plate 500 without having to provide the exterior member 20 with work such as providing another through hole. Further, in this wire harness 1, by making the mesh through holes 21 of the exterior member 20 smaller than the electric wire routing pins 510, misalignment of the exterior member 20 on the jig plate 500 can be prevented by utilizing the mesh through holes 21 of the exterior member 20 and the electric wire routing pins 510.

In this exemplified jig plate 500, a set of two electric wire routing pins 510 are disposed at three places and a set of three electric wire routing pins 510 are disposed at one place (FIG. 3 to FIG. 10). In this exemplified inner layer installing process, parts 11 to be protected of two routed electric wires 10 are routed to the exterior member 20A as the one outer layer.

The pair of electric wire routing pins 510 are, at all the three places, disposed at places for drawing out the routed electric wire 10 the part 11 to be protected of which is held between the pair of exterior members 20 to the outside from between the pair of exterior members 20 (places that are what are called electric wire draw-out ports) (FIG. 3 to FIG. 10). One pair of the three pairs of electric wire routing pins 510 at the three places (a pair of electric wire routing pins 510A) are disposed at a place provided with an electric wire draw-out port for drawing out one ends of the two routed electric wires 10 to the outside from between the pair of exterior members 20 (FIG. 5). As to the two pairs of electric wire routing pins 510 at the remaining two places, one pair of them (a pair of electric wire routing pins 510B) are disposed at a place provided with an electric wire draw-out port for drawing out the other end of one routed electric wire 10 to the outside, whereas the other pair of them (a pair of electric wire routing pins 510C) are disposed at a place provided with an electric wire draw-out port for drawing out the other end of the other routed electric wire 10 to the outside (FIG. 5).

The set of three electric wire routing pins 510 (510D) are disposed at respective apexes of a triangle, and three gaps between two electric wire routing pins 510D are formed (FIG. 3 to FIG. 8). In these three electric wire routing pins 510D, the parts 11 to be protected of the two routed electric wires 10 having been passed through a gap of the pair of electric wire routing pins 510A are passed through one of the three gaps (FIG. 5). In these three electric wire routing pins 510D, the part 11 to be protected of the one routed electric wire 10 is passed through one of the remaining two gaps, whereas the part 11 to be protected of the other routed electric wire 10 is passed through the other of them (FIG. 5). These three electric wire routing pins 510D route the part 11 to be protected of the one routed electric wire 10 having been passed through the one gap thereof toward the pair of electric wire routing pins 510B and route the part 11 to be protected of the other routed electric wire 10 having been passed through the other gap thereof toward the pair of electric wire routing pins 510C (FIG. 5).

In this example, only one layer by the parts 11 to be protected of the two routed electric wires 10 forms the electric wire layer. Thus, this exemplified inner layer installing process can be said to be an electric wire installing process in which only the parts 11 to be protected of the routed electric wires 10 are routed.

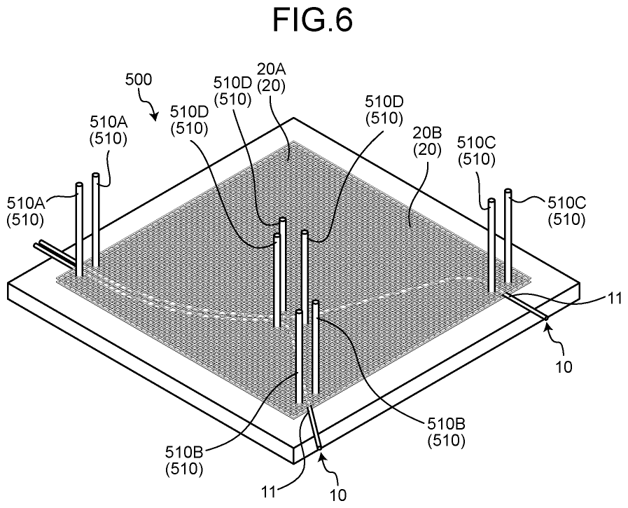

At the second outer layer installing process, the exterior member 20B as the other outer layer among the exterior members 20 is overlaid on the part 11 to be protected and the exterior member 20 on which the part 11 to be protected has been placed (FIG. 6). At this exemplified second outer layer installing process, when the exterior member 20B as the other outer layer is installed, the electric wire routing pins 510 are inserted into the mesh through holes of the exterior member 20B as in the first outer layer installing process. At this exemplified second outer layer installing process, the exterior member 20B as the other outer layer is overlaid on the parts 11 to be protected of the two routed electric wires 10 and the exterior member 20A as the one outer layer on which the two parts 11 to be protected have been placed.

In this method of manufacture, by ending to perform its second outer layer installing process, the harness assembling process for a wire harness 1A as a first set is ended. In this method of manufacture, before entering the harness assembling process for a wire harness 1B as a second set, the mold release member installing process is performed (FIG. 7).

At the mold release member installing process, the mold release member 600 is placed on the wire harness 1A for which the harness assembling process has been ended (that is, on the exterior member 20B as the other outer layer of this wire harness 1A) (FIG. 7). The mold release member 600 is formed in a sheet shape and is disposed between the two wire harnesses 1 (1A and 1B) so that the exterior members 20 do not stick to each other. This mold release member 600 is, for example, molded in the same size as or larger than the exterior member 20 and is placed on the wire harness 1A, for which the harness assembling process has been ended, so as to cover the exterior member 20B as the other outer layer. For example, in this example, what is called mold release paper, mold release film, or the like is used as the mold release member 600.

At this exemplified mold release member installing process, the electric wire routing pins 510 are present immediately below the mold release member 600. Thus, the mold release member 600 is formed in a mesh shape like the exterior member 20 in order to insert the electric wire routing pins 510 for the respective electric wire routing pins 510, and the electric wire routing pins 510 are inserted into the mesh through holes. The mold release member 600, if not formed in a mesh shape, in accordance with the arrangement of the electric wire routing pins 510 on the jig plate 500, may be provided with through holes into which the respective electric wire routing pins 510 can be inserted for the respective electric wire routing pins 510.

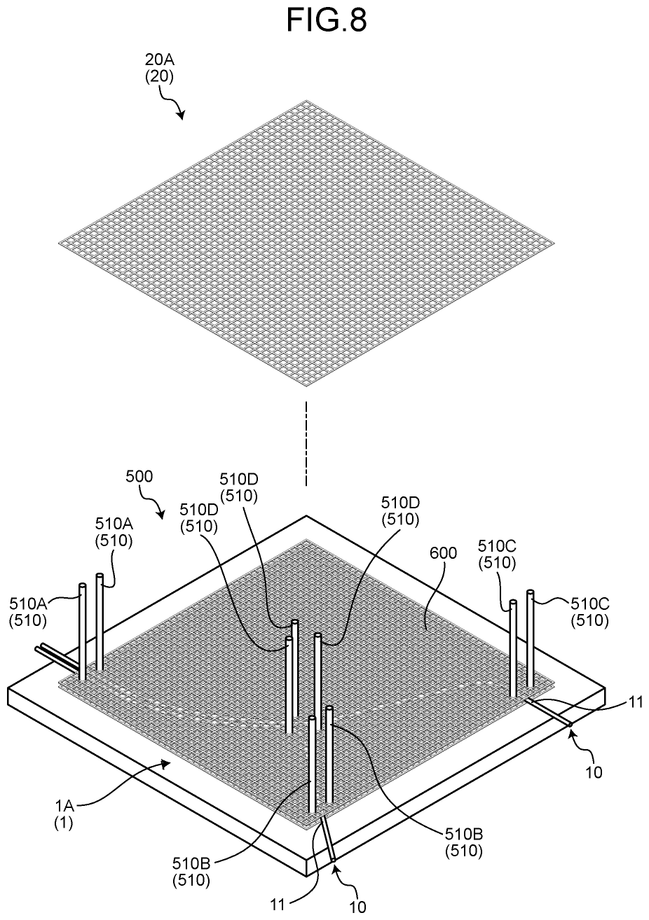

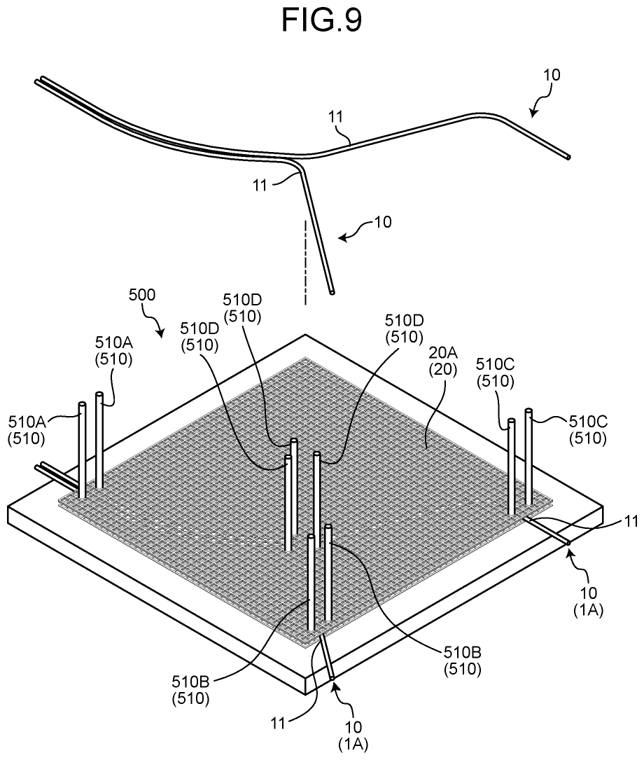

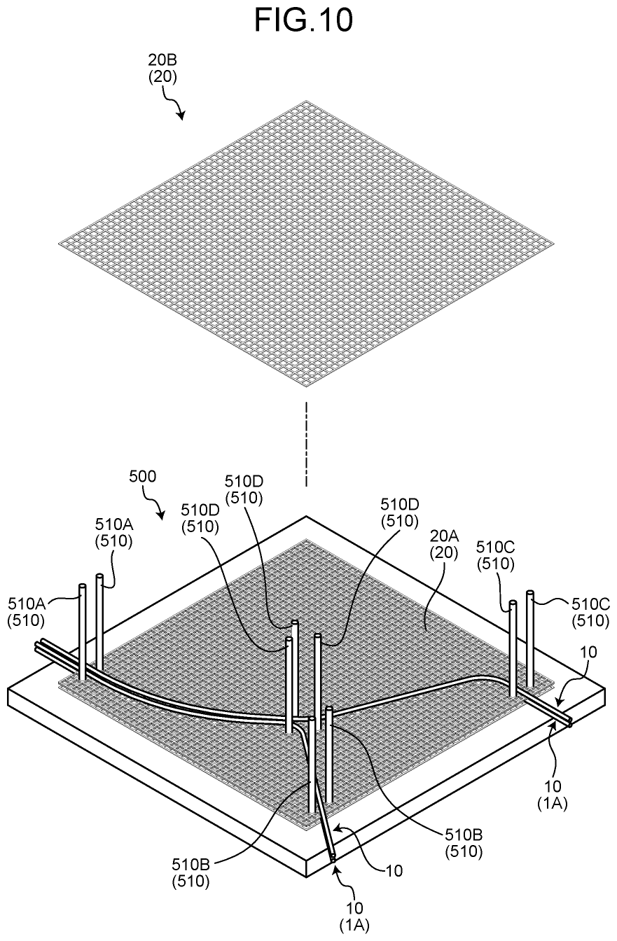

In this method of manufacture, the mold release member 600 is placed on the wire harness 1A (on the exterior member 20B as the other outer layer), and then the harness assembling process for the wire harness 1B as a next set is started (FIG. 8 to FIG. 10). As to this wire harness 1B as the second set, at the first outer layer installing process, the exterior member 20A as the one outer layer among the exterior members 20 is placed on the mold release member 600 (FIG. 8). Then, at the inner layer installing process, the part 11 to be protected of the at least one routed electric wire 10 is routed to the exterior member 20A as the one outer layer (FIG. 9). At the second outer layer installing process, the exterior member 20B as the other outer layer among the exterior members 20 is overlaid on the part 11 to be protected and the exterior member 20 on which the part 11 to be protected has been placed (the exterior member 20A as the one outer layer) (FIG. 10 and FIG. 11).

In this method of manufacture, until the harness assembling process for the wire harness 1 as a last set is ended, the harness assembling process and the mold release member installing process are alternately repeated. In this example, the wire harnesses 1B as the second set is the last set.

In this method of manufacture, the joining process may be performed each time the harness assembling process is ended or the joining process may be performed after the harness assembling process for all the wire harnesses 1 is ended. In this example, the joining process is performed after the harness assembling process for all the wire harnesses 1 is ended.

At the joining process, for each wire harness 1, the exterior members 20 of the wire harness 1 are joined together. In the wire harness 1, by undergoing this joining process, the joints 25 are formed for each set. At the joints 25, for each pair of exterior members 20 overlaid on each other, at least portions of the pair of exterior members 20 are bonded or welded together by the exterior members 20.

For example, at the joining process, for each wire harness 1, at least portions of the exterior member 20A as the one outer layer and the exterior member 20B as the other outer layer overlaid on each other may be bonded together with an adhesive. At the joining process, by causing the exterior members 20 to have adhesiveness or adsorptivity, for each wire harness 1, the exterior member 20A as the one outer layer and the exterior member 20B as the other outer layer overlaid on each other may be caused to self-adhere to each other.

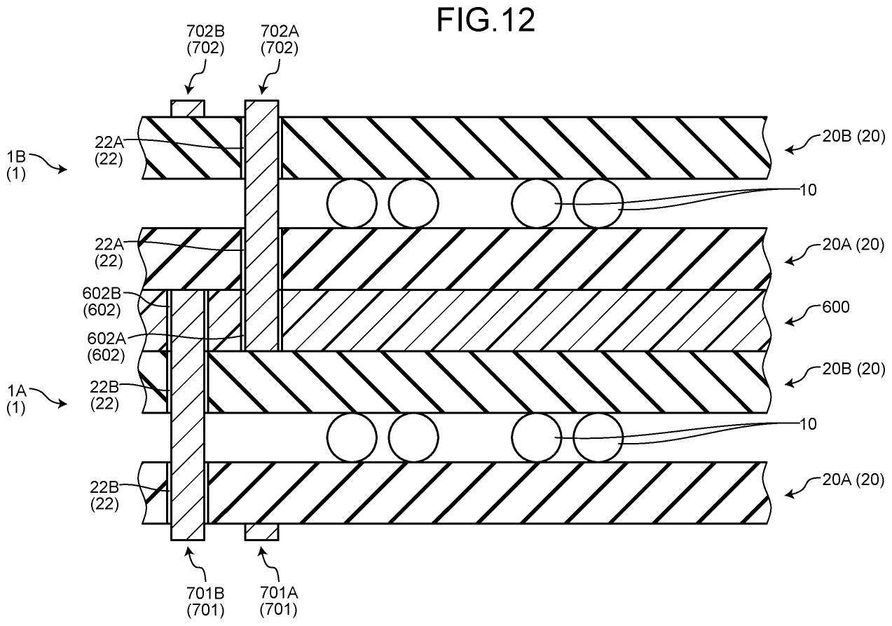

At the joining process, for each wire harness 1, at least portions of the exterior member 20A as the one outer layer and the exterior member 20B as the other outer layer overlaid on each other may be welded together using a well-known welding technique such as ultrasonic welding. For example, at this joining process, the exterior member 20A as the one outer layer and the exterior member 20B as the other outer layer overlaid on each other are held between an anvil 701 and a horn 702 and pressurized, and ultrasonic vibration is transmitted from the horn 702 to the exterior member 20A and the exterior member 20B to weld at least portions of the exterior member 20A and the exterior member 20B together (FIG. 12). In this example, the exterior member 20 is molded in a mesh shape, and thus the anvil 701 and the horn 702 thicker than its mesh through holes are used.

The joining process disclosed here is a process of, using the anvil 701 and the horn 702 prepared for each wire harness 1, for each wire harness 1, holding the exterior member 20A as the one outer layer and the exterior member 20B as the other outer layer of the wire harness 1 between the anvil 701 and the horn 702 to pressurize the exterior members and welding the exterior members 20 of the wire harness 1 together through ultrasonic vibration applied from the horn 702. Thus, at this joining process, a combination of the anvil 701 and the horn 702 disposed staggered for each wire harness 1 is used.

At this joining process, when, closer to the exterior member 20A as the one outer layer of the wire harness 1 to be joined, the mold release member 600 and the other wire harness 1 different from the wire harness 1 to be joined are present, a tip of the anvil 701 inserted into a through hole of the mold release member 600 (hereinafter, referred to as a “joint member insertion hole”) 602 and a through hole of the exterior members 20 of the other wire harness 1 (hereinafter referred to as a “joint member insertion hole”) 22 is brought into contact with the exterior member 20A as the one outer layer of the wire harness 1 to be joined and when, closer to the exterior member 20B as the other outer layer of the wire harness 1 to be joined, the mold release member 600 and the other wire harness 1 different from the wire harness 1 to be joined are present, a tip of the horn 702 inserted into the joint member insertion hole 602 of the mold release member 600 and the joint member insertion hole 22 of the exterior members 20 of the other wire harness 1 is brought into contact with the exterior member 20B as the other outer member of the wire harness 1 to be joined (FIG. 12).

At this exemplified joining process, the exterior member 20A as the one outer layer and the exterior member 20B as the other outer layer of the wire harness 1A as the first set are held between an anvil 701A and a horn 702A (FIG. 12). Thus, in performing this joining process, the joint member insertion holes 602 and 22 for allowing a tip of the horn 702A to reach the exterior member 20B as the other outer layer of the wire harness 1A as the first set are formed in advance in all the mold release members 600 closer to the exterior member 20B as the other outer layer of the wire harness 1A as the first set and the exterior members 20 of the wire harnesses 1 as the second and subsequent sets (the wire harness 1B and the like). In this example, a joint member insertion hole 602A for insertion of the horn 702A is formed in the mold release member 600 placed on the wire harness 1A as the first set and a joint member insertion hole 22A for insertion of the horn 702A is formed in the exterior member 20A as the one outer layer and the exterior member 20B as the other outer layer of the wire harness 1B as the second set (FIG. 12). At this joining process, the anvil 701A is erected from the jig plate 500. However, at this joining process, the jig plate 500 may be utilized as the anvil 701A.

At this joining process, the exterior member 20A as the one outer layer and the exterior member 20B as the other outer layer of the wire harness 1B as the second set are held between an anvil 701B and a horn 702B. Thus, in performing this joining process, joint member insertion holes 602B and 22B for allowing a tip of the anvil 701B to reach the exterior member 20A as the one outer layer of the wire harness 1B as the second set are formed in the mold release member 600 between the wire harnesses 1A and 1B as the first set and the second set and the exterior member 20A as the one outer layer and the exterior member 20B as the other outer layer of the wire harness 1A as the first set (FIG. 12). At the harness assembling process for the wire harness 1A as the first set, when the exterior member 20A as the one outer layer and the exterior member 20B as the other outer layer are installed at the first outer layer installing process and the second outer layer installing process, the anvil 701B, for example, erected from the jig plate 500 is inserted into the joint member insertion hole 22B. At the mold release member installing process, when the mold release member 600 is placed on the wire harness 1A as the first set, the anvil 701B is inserted into the joint member insertion hole 602B.

When the wire harnesses 1 as third and subsequent sets are also assembled, in performing this joining process, the joint member insertion holes 602A and 22B for allowing the tip of the horn 702A to reach the exterior member 20B as the other outer layer of the wire harness 1A as the first set are formed in advance in all the mold release members 600 disposed closer to the exterior member 20B as the other outer layer of the wire harness 1B as the second set and the exterior members 20 of the wire harnesses 1 as the third and subsequent sets. The joint member insertion holes 602B and 22B for allowing a tip of the horn 702B to reach the exterior member 20B as the other outer layer of the wire harness 1B as the second set are formed in advance in the mold release members 600 and the exterior members 20 of the wire harnesses 1 as the third and subsequent sets.

The joint member insertion holes 22 and 602 of the exterior members 20 and the mold release member 600, respectively, are provided for each combination of the anvil 701 and the horn 702 as appropriate.

In the wire harness 1 as the last set in an assembly order, the exterior member 20B as the other outer layer is a last layer, with the mold release member 600 not being placed on this exterior member 20B, and thus the tip of the horn 702 can be brought into contact with this exterior member 20B. In this exemplified method of manufacture, two wire harnesses 1 are assembled. Thus, in this example, the exterior member 20B as the other outer layer of the wire harness 1B as the second set is the last layer.

The foregoing has described the harness assembling process in which there is only one electric wire layer interposed between the exterior member 20A as the one outer layer and the exterior member 20B as the other outer layer. Now, the following describes the harness assembling process when a plurality of electric wire layers are disposed between the exterior member 20A as the one outer layer and the exterior member 20B as the other outer layer.

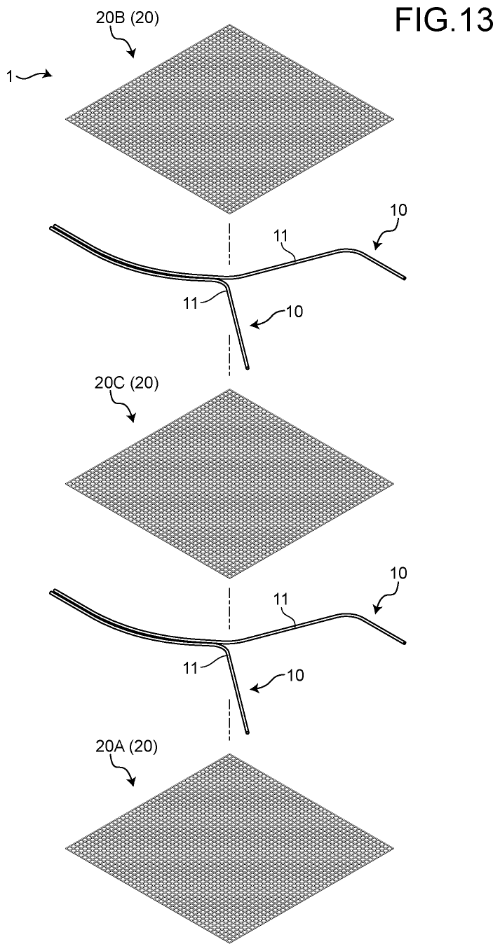

In this case, the inner layer installing process is a process of alternately repeating routing of the part 11 to be protected and installation of an exterior member 20C as an inner layer among the exterior members 20 in accordance with the number of layers of the part 11 to be protected interposed between the exterior member 20A as the one outer layer and the exterior member 20B as the other outer layer (FIG. 13). At this inner layer installing process, in accordance with the number of layers of the part 11 to be protected, routing of the part 11 to be protected to the exterior member 20 and overlaying of the exterior member 20C as the inner layer on the part 11 to be protected and the exterior member 20 on which the part 11 to be protected has been placed are alternately repeated until the exterior member 20C as the inner layer becomes the last layer, and then the part 11 to be protected as a last layer is routed to the exterior member 20C as the inner layer as the last layer.

For example, at the inner layer installing process, the part 11 to be protected of at least one (two in a specific example) routed electric wire 10 is routed to the exterior member 20A as the one outer layer, and one exterior member 20C as the inner layer is overlaid on the part 11 to be protected and the exterior member 20A as the one outer layer on which the part 11 to be protected has been placed. At this inner layer installing process, when the electric wire routing pins 510 are present immediately below the exterior member 20C as the inner layer, when the exterior member 20C is installed, the electric wire routing pins 510 are inserted into the mesh through holes 21 of this exterior member 20C. At this inner layer installing process, the anvil 701 is inserted into the joint member insertion hole 22 of the exterior member 20C as the inner layer as appropriate. At the joining process, the horn 702 is inserted into the joint member insertion hole 22 of the exterior member 20C as the inner layer as appropriate, and using the anvil 701 and the horn 702, the exterior member 20A as the one outer layer, the exterior member 20C as the inner layer, and the exterior member 20B as the other outer layer are ultrasonically welded together.

In this specific example, the exterior member 20C is the exterior member 20C as the inner layer as the last layer, and thus the part 11 to be protected of at least one (two in this case) routed electric wire 10 is routed to this exterior member 20C as the inner layer as the last layer as the part 11 to be protected as the last layer. Thus, at the second outer layer installing process, the exterior member 20B as the other outer layer is overlaid on the part 11 to be protected as the last layer and the exterior member 20C as the inner layer as the last layer on which the part 11 to be protected as the last layer has been placed.

As shown above, the method for manufacturing the wire harness 1 of the present embodiment, simply by holding the part 11 to be protected of the routed electric wire 10 between the pair of exterior members 20, can assemble the exterior members 20 to the part 11 to be protected. Thus, this method for manufacturing the wire harness 1 does not require to wind adhesive tape around the part 11 to be protected or insert the part 11 to be protected into a corrugated tube as in conventional examples, and thus even if the routing path for the routed electric wire 10 is complicated or the routed electric wire 10 is branched, the exterior members 20 can be assembled to the part 11 to be protected without relying on manual work. This method for manufacturing the wire harness 1 disposes the mold release member 600 each time its harness assembling process is ended by the same method of installation as that for the exterior members 20 until the harness assembling process for the wire harness 1 as the last set is ended and can thus successively assemble a plurality of wire harnesses 1. Consequently, the method for manufacturing the wire harness 1 of the present embodiment contributes to automation of its manufacturing process and can thus reduce costs.

By the way, ultrasonic welding is applied to join the exterior members 20 together at the above exemplified joining process, but the joining process may alternatively join the exterior members 20 together by heat welding. In this example, the anvil 701 and the horn 702 disclosed in the description of ultrasonic welding are replaced by a first electrode 701 and a second electrode 702, respectively.

This joining process is a process of, using the first electrode 701 and the second electrode 702 prepared for each wire harness 1, for each wire harness 1, holding the exterior member 20A as the one outer layer and the exterior member 20B as the other outer layer of the wire harness 1 between the first electrode 701 and the second electrode 702 to pressurize the exterior members and heating the exterior members 20 of the wire harness 1 along with energization between the first electrode 701 and the second electrode 702 to heat-weld the exterior members together.

At this joining process, when, closer to the exterior member 20A as the one outer layer of the wire harness 1 to be joined, the mold release member 600 and the other wire harness 1 different from the wire harness 1 to be joined are present, a tip of the first electrode 701 inserted into the joint member insertion hole 602 of the mold release member 600 and the joint member insertion hole 22 of the exterior members 20 of the other wire harness 1 is brought into contact with the exterior member 20A as the one outer layer of the wire harness 1 to be joined and when, closer to the exterior member 20B as the other outer layer of the wire harness 1 to be joined, the mold release member 600 and the other wire harness 1 different from the wire harness 1 to be joined are present, a tip of the second electrode 702 inserted into the joint member insertion hole 602 of the mold release member 600 and the joint member insertion hole 22 of the exterior members 20 of the other wire harness 1 is brought into contact with the exterior member 20B as the other outer layer of the wire harness 1 to be joined (FIG. 12).

At this exemplified joining process, the exterior member 20A as the one outer layer and the exterior member 20B as the other outer layer of the wire harness 1A as the first set are held between a first electrode 701A and a second electrode 702A (FIG. 12). Thus, in performing this joining process, the joint member insertion holes 602 and 22 for allowing a tip of the second electrode 702A to reach the exterior member 20B as the other outer layer of the wire harness 1A as the first set are formed in advance in all the mold release members 600 closer to the exterior member 20B as the other outer layer of the wire harness 1A as the first set and the exterior members 20 of the wire harnesses 1 as the second and subsequent sets (the wire harness 1B and the like). In this example, the joint member insertion hole 602A for insertion of the second electrode 702A is formed in the mold release member 600 placed on the wire harness 1A as the first set and the joint member insertion hole 22A for insertion of the second electrode 702A is formed in the exterior member 20A as the one outer layer and the exterior member 20B as the other outer layer of the wire harness 1B as the second set (FIG. 12). At this joining process, the first electrode 701A is erected from the jig plate 500. However, at this joining process, the jig plate 500 may be utilized as the first electrode 701A.

At this joining process, the exterior member 20A as the one outer layer and the exterior member 20B as the other outer layer of the wire harness 1B as the second set are held between a first electrode 701B and a second electrode 702B. Thus, in performing this joining process, the joint member insertion holes 602B and 22B for allowing a tip of the first electrode 701B to reach the exterior member 20A as the one outer layer of the wire harness 1B as the second set are formed in the mold release member 600 between the wire harnesses 1A and 1B as the first set and the second set and the exterior member 20A as the one outer layer and the exterior member 20B as the other outer layer of the wire harness 1A as the first set (FIG. 12). At the harness assembling process for the wire harness 1A as the first set, when the exterior member 20A as the one outer layer and the exterior member 20B as the other outer layer are installed at the first outer layer installing process and the second outer layer installing process, the first electrode 701B, for example, erected from the jig plate 500 is inserted into the joint member insertion hole 22B. At the mold release member installing process, when the mold release member 600 is placed on the wire harness 1A as the first set, the first electrode 701B is inserted into the joint member insertion hole 602B.

When the wire harnesses 1 as the third and subsequent sets are also assembled, in performing this joining process, the joint member insertion holes 602A and 22B for allowing the tip of the second electrode 702A to reach the exterior member 20B as the other outer layer of the wire harness 1A as the first set are formed in advance in all the mold release members 600 disposed closer to the exterior member 20B as the other outer layer of the wire harness 1B as the second set and the exterior members 20 of the wire harnesses 1 as the third and subsequent sets. The joint member insertion holes 602B and 22B for allowing a tip of the second electrode 702B to reach the exterior member 20B as the other outer layer of the wire harness 1B as the second set are formed in advance in the mold release members 600 and the exterior members 20 of the wire harnesses 1 as the third and subsequent sets.

The joint member insertion holes 22 and 602 of the exterior members 20 and the mold release member 600, respectively, are provided for each combination of the first electrode 701 and the second electrode 702 as appropriate.

In this example, the exterior member 20B as the other outer layer of the wire harness 1B as the second set is the last layer, with the mold release member 600 not being placed on this exterior member 20B, and thus the tip of the second electrode 702 can be brought into contact with this exterior member 20B.

At this exemplified inner layer installing process, when a plurality of electric wire layers are disposed between the exterior member 20A as the one outer layer and the exterior member 20B as the other outer layer, the first electrode 701 is inserted into the joint member insertion hole 22 of the exterior member 20C as the inner layer as appropriate. At the joining process, the second electrode 702 is inserted into the joint member insertion hole 22 of the exterior member 20C as the inner layer as appropriate, and using the first electrode 701 and the second electrode 702, the exterior member 20A as the one outer layer, the exterior member 20C as the inner layer, and the exterior member 20B as the other outer layer are heat-welded together.

Further, at the joining process, the exterior members 20 may be joined together by high-frequency welding.

This joining process is a process of, for each wire harness 1, applying microwaves from an electron gun (not shown) to the exterior member 20B as the other outer layer of the wire harness 1 and high-frequency welding the exterior members 20 of the wire harness together.

At this joining process, when, closer to the exterior member 20A as the one outer layer of the wire harness 1 to be joined, the mold release member 600 and the other wire harness 1 different from the wire harness 1 to be joined are present, the microwaves emitted from the electron gun are applied to the exterior member 20B as the other outer layer of the wire harness 1 to be joined through a through hole of the mold release member 600 (hereinafter, referred to as a “microwave application hole”) 602 and a through hole of the exterior member 20 of the other wire harness 1 (hereinafter, referred to as a “microwave application hole”) 22. In this example, the joint member insertion holes 602 and 22 disclosed in the description of ultrasonic welding are replaced by the microwave application holes 602 and 22, respectively.

Specifically, this joining process is a process of, using a first pressurizing member 701 and a second pressurizing member 702 prepared for each wire harness 1, for each wire harness 1, holding the exterior member 20A as the one outer layer and the exterior member 20B as the other outer layer of the wire harness 1 between the first pressurizing member 701 and the second pressurizing member 702 to pressurize the exterior members and applying the microwaves from the electron gun to the exterior member 20B as the other outer layer of the wire harness 1 to high-frequency weld the exterior members 20 of the wire harness together. In this example, the anvil 701 and the horn 702 disclosed in the description of ultrasonic welding are replaced with the first pressurizing member 701 and the second pressurizing member 702, respectively.

At this joining process, when, closer to the exterior member 20A as the one outer layer of the wire harness 1 to be joined, the mold release member 600 and the other wire harness 1 different from the wire harness 1 to be joined are present, a tip of the first pressurizing member 701 inserted into the microwave application hole 602 of the mold release member 600 and the microwave application hole 22 of the exterior members 20 of the other wire harness 1 is brought into contact with the exterior member 20A as the one outer layer of the wire harness 1 to be joined and when, closer to the exterior member 20B as the other outer layer of the wire harness 1 to be joined, the mold release member 600 and the other wire harness 1 different from the wire harness 1 to be joined are present, a tip of the second pressurizing member 702 inserted into the microwave application hole 602 of the mold release member 600 and the microwave application hole 22 of the exterior members 20 of the other wire harness 1 is brought into contact with the exterior member 20B as the other outer layer of the wire harness 1 to be joined. At this joining process, the microwaves emitted from the electron gun are applied to the exterior member 20B as the other outer layer of the wire harness 1 to be joined through the inside of the tubular second pressurizing member 702.

At this exemplified joining process, the exterior member 20A as the one outer layer and the exterior member 20B as the other outer layer of the wire harness 1A as the first set are held between a first pressurizing member 701A and a second pressurizing member 702A. Thus, in performing this joining process, the microwave application holes 602 and 22 for allowing a tip of the second pressurizing member 702A to reach the exterior member 20B as the other outer layer of the wire harness 1A as the first set are formed in advance in all the mold release members 600 closer to the exterior member 20B as the other outer layer of the wire harness 1A as the first set and the exterior members 20 of the wire harnesses 1 as the second and subsequent sets (the wire harness 1B and the like). In this example, a microwave application hole 602A for insertion of the second pressurizing member 702A is formed in the mold release member 600 placed on the wire harness 1A as the first set and a microwave application hole 22A for insertion of the second pressurizing member 702A is formed in the exterior member 20A as the one outer layer and the exterior member 20B as the other outer layer of the wire harness 1B as the second set. At this joining process, the first pressurizing member 701A is erected from the jig plate 500. However, at this joining process, the jig plate 500 may be utilized as the first pressurizing member 701A.

At this joining process, the exterior member 20A as the one outer layer and the exterior member 20B as the other outer layer of the wire harness 1B as the second set are held between a first pressurizing member 701B and a second pressurizing member 702B. Thus, in performing this joining process, microwave application holes 602B and 22B for allowing a tip of the first pressurizing member 701B to reach the exterior member 20A as the one outer layer of the wire harness 1B as the second set are formed in the mold release member 600 between the wire harnesses 1A and 1B as the first set and the second set and the exterior member 20A as the one outer layer and the exterior member 20B as the other outer layer of the wire harness 1A as the first set. At the harness assembling process for the wire harness 1A as the first set, when the exterior member 20A as the one outer layer and the exterior member 20B as the other outer layer are installed at the first outer layer installing process and the second outer layer installing process, the first pressurizing member 701B, for example, erected from the jig plate 500 is inserted into the microwave application hole 22B. At the mold release member installing process, when the mold release member 600 is placed on the wire harness 1A as the first set, the first pressurizing member 701B is inserted into the microwave application hole 602B.

When the wire harnesses 1 as the third and subsequent sets are also assembled, in performing this joining process, the microwave application holes 602A and 22B for allowing the tip of the second pressurizing member 702A to reach the exterior member 20B as the other outer layer of the wire harness 1A as the first set are formed in advance in all the mold release members 600 disposed closer to the exterior member 20B as the other outer layer of the wire harness 1B as the second set and the exterior members 20 of the wire harnesses 1 as the third and subsequent sets. The microwave application holes 602B and 22B for allowing the tip of the second pressurizing member 702B to reach the exterior member 20B as the other outer layer of the wire harness 1B as the second set are formed in advance in the mold release members 600 and the exterior members 20 of the wire harnesses 1 as the third and subsequent sets.

The microwave application holes 22 and 602 of the exterior members 20 and the mold release member 600, respectively, are provided for each combination of the first pressurizing member 701 and the second pressurizing member 702 as appropriate.

In this example, the exterior member 20B as the other outer layer of the wire harness 1B as the second set is the last layer, with the mold release member 600 not being placed on this exterior member 20B, and thus the tip of the second pressurizing member 702 can be brought into contact with this exterior member 20B. However, in this method of manufacture, if the exterior member 20A as the one outer layer and the exterior member 20B as the other outer layer of the wire harness 1B as the second set are in contact with each other without being pressurized, the microwaves may be applied from the electron gun to the exterior member 20B as the other outer layer at the joining process without providing the first pressurizing member 701 and the second pressurizing member 702 for this wire harness 1B as the second set.

In this exemplified inner layer installing process, when a plurality of electric wire layers are disposed between the exterior member 20A as the one outer layer and the exterior member 20B as the other outer layer, the first pressurizing member 701 is inserted into the microwave application hole 22 of the exterior member 20C as the inner layer. At the joining process, the second pressurizing member 702 is inserted into the microwave application hole 22 of the exterior member 20C as the inner layer as appropriate, and using the first pressurizing member 701 and the second pressurizing member 702, the exterior member 20A as the one outer layer, the exterior member 20C as the inner layer, and the exterior member 20B as the other outer layer are held therebetween and pressurized. At this joining process, the microwaves emitted from the electron gun are applied to the exterior member 20B as the other outer layer through the inside of the tubular second pressurizing member 702 to high-frequency weld the exterior member 20A as the one outer layer, the exterior member 20C as the inner layer, and the exterior member 20B as the other outer layer together.

The method for manufacturing a wire harness according to the present embodiment, simply by holding the protection target part of the routed electric wire between the pair of exterior members, can assemble the exterior members to the protection target part. Thus, this method for manufacturing a wire harness does not require to wind adhesive tape around the protection target part or insert the protection target part into a corrugated tube as in conventional examples, and thus even if the routing path for the routed electric wire is complicated or the routed electric wire is branched, the exterior members can be assembled to the protection target part without relying on manual work. This method for manufacturing a wire harness disposes the mold release member each time its harness assembling process is ended by the same method of installation as that for the exterior members until the harness assembling process for the wire harness as the last set is ended and can thus successively assemble a plurality of wire harnesses. Consequently, the method for manufacturing a wire harness according to the present invention contributes to automation of its manufacturing process and can thus reduce costs.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A method for manufacturing a wire harness, the method comprising:
a harness assembling process of assembling a wire harness;
a mold release member installing process of, when a plurality of the wire harnesses are assembled, each time the harness assembling process is ended, placing a mold release member capable of preventing the wire harnesses adjacent to each other from sticking to each other on the wire harness for which the harness assembling process has been ended; and
a joining process of joining components of the wire harness to each other for each wire harness, wherein
the harness assembling process includes:
a first outer layer installing process of installing, among a plurality of mesh-like and sheet-like exterior members provided with insulation on outer surfaces, the exterior member as one outer layer on a jig plate;
an inner layer installing process of routing a protection target part of at least one routed electric wire to the exterior member as the one outer layer; and
a second outer layer installing process of overlaying the exterior member as another outer layer among the exterior members on the protection target part and the exterior member on which the protection target part has been placed, and
at the joining process, the exterior members of the wire harness are joined together for each wire harness.

2. The method for manufacturing a wire harness according to claim 1, wherein
the joining process is, using an anvil and a horn prepared for each wire harness, for each wire harness, holding the exterior member as the one outer layer and the exterior member as the other outer layer of the wire harness between the anvil and the horn to pressurize the exterior members and welding the exterior members of the wire harness together through ultrasonic vibration applied from the horn, and
at the joining process, when, closer to the exterior member as the one outer layer of the wire harness to be joined, the mold release member and the other wire harness different from the wire harness to be joined are present, a tip of the anvil inserted into a joint member insertion hole of the mold release member and a joint member insertion hole of the exterior members of the other wire harness is brought into contact with the exterior member as the one outer layer of the wire harness to be joined and when, closer to the exterior member as the other outer layer of the wire harness to be joined, the mold release member and the other wire harness different from the wire harness to be joined are present, a tip of the horn inserted into a joint member insertion hole of the mold release member and a joint member insertion hole of the exterior members of the other wire harness is brought into contact with the exterior member as the other outer layer of the wire harness to be joined.

3. The method for manufacturing a wire harness according to claim 1, wherein
the joining process is, using a first electrode and a second electrode prepared for each wire harness, for each wire harness, holding the exterior member as the one outer layer and the exterior member as the other outer layer of the wire harness between the first electrode and the second electrode to pressurize the exterior members and heating the exterior members of the wire harness along with energization between the first electrode and the second electrode to heat-weld the exterior members together, and
at the joining process, when, closer to the exterior member as the one outer layer of the wire harness to be joined, the mold release member and the other wire harness different from the wire harness to be joined are present, a tip of the first electrode inserted into a joint member insertion hole of the mold release member and a joint member insertion hole of the exterior members of the other wire harness is brought into contact with the exterior member as the one outer layer of the wire harness to be joined and when, closer to the exterior member as the other outer layer of the wire harness to be joined, the mold release member and the other wire harness different from the wire harness to be joined are present, a tip of the second electrode inserted into a joint member insertion hole of the mold release member and a joint member insertion hole of the exterior members of the other wire harness is brought into contact with the exterior member as the other outer layer of the wire harness to be joined.

4. The method for manufacturing a wire harness according to claim 1, wherein
the joining process is, for each wire harness, applying microwaves from an electron gun to the exterior member as the other outer layer of the wire harness to high-frequency weld the exterior members of the wire harness together, and
at the joining process, when, closer to the exterior member as the one outer layer of the wire harness to be joined, the mold release member and the other wire harness different from the wire harness to be joined are present, the microwaves emitted from the electron gun are applied to the exterior member as the other outer layer of the wire harness to be joined through a microwave application hole of the mold release member and a microwave application hole of the exterior members of the other wire harness.

5. The method for manufacturing a wire harness according to claim 1, wherein
the inner layer installing process is alternately repeating routing of the protection target part and installation of the exterior member as an inner layer among the exterior members in accordance with a number of layers of the protection target part interposed between the exterior member as the one outer layer and the exterior member as the other outer layer,
as the inner layer installing process, routing of the protection target part to the exterior member and overlaying of the exterior member as the inner layer on the protection target part and the exterior member on which the protection target part has been placed are alternately repeated until the exterior member as the inner layer becomes a last layer in accordance with the number of layers of the protection target part, and then the protection target part as a last layer is routed to the exterior member as the inner layer as the last layer, and
at the second outer layer installing process, the exterior member as the other outer layer is overlaid on the protection target part as the last layer and the exterior member as the inner layer as the last layer on which the protection target part as the last layer has been placed.

6. The method for manufacturing a wire harness according to claim 2, wherein
the inner layer installing process is alternately repeating routing of the protection target part and installation of the exterior member as an inner layer among the exterior members in accordance with a number of layers of the protection target part interposed between the exterior member as the one outer layer and the exterior member as the other outer layer,
as the inner layer installing process, routing of the protection target part to the exterior member and overlaying of the exterior member as the inner layer on the protection target part and the exterior member on which the protection target part has been placed are alternately repeated until the exterior member as the inner layer becomes a last layer in accordance with the number of layers of the protection target part, and then the protection target part as a last layer is routed to the exterior member as the inner layer as the last layer, and
at the second outer layer installing process, the exterior member as the other outer layer is overlaid on the protection target part as the last layer and the exterior member as the inner layer as the last layer on which the protection target part as the last layer has been placed.

7. The method for manufacturing a wire harness according to claim 3, wherein
the inner layer installing process is alternately repeating routing of the protection target part and installation of the exterior member as an inner layer among the exterior members in accordance with a number of layers of the protection target part interposed between the exterior member as the one outer layer and the exterior member as the other outer layer,
as the inner layer installing process, routing of the protection target part to the exterior member and overlaying of the exterior member as the inner layer on the protection target part and the exterior member on which the protection target part has been placed are alternately repeated until the exterior member as the inner layer becomes a last layer in accordance with the number of layers of the protection target part, and then the protection target part as a last layer is routed to the exterior member as the inner layer as the last layer, and
at the second outer layer installing process, the exterior member as the other outer layer is overlaid on the protection target part as the last layer and the exterior member as the inner layer as the last layer on which the protection target part as the last layer has been placed.

8. The method for manufacturing a wire harness according to claim 4, wherein
the inner layer installing process is alternately repeating routing of the protection target part and installation of the exterior member as an inner layer among the exterior members in accordance with a number of layers of the protection target part interposed between the exterior member as the one outer layer and the exterior member as the other outer layer,
as the inner layer installing process, routing of the protection target part to the exterior member and overlaying of the exterior member as the inner layer on the protection target part and the exterior member on which the protection target part has been placed are alternately repeated until the exterior member as the inner layer becomes a last layer in accordance with the number of layers of the protection target part, and then the protection target part as a last layer is routed to the exterior member as the inner layer as the last layer, and
at the second outer layer installing process, the exterior member as the other outer layer is overlaid on the protection target part as the last layer and the exterior member as the inner layer as the last layer on which the protection target part as the last layer has been placed.

9. The method for manufacturing a wire harness according to claim 1, wherein
at the inner layer installing process, when the protection target part is routed, the protection target part is passed through a gap between two electric wire routing pins disposed along a routing path for the protection target part on the jig plate, and
at the first outer layer installing process and the second outer layer installing process, when the exterior member is installed in each of the first outer layer installing process and the second outer layer installing process, the electric wire routing pins are inserted into mesh through holes of the exterior member, with the electric wire routing pins being thicker than the through holes.

10. The method for manufacturing a wire harness according to claim 2, wherein
at the inner layer installing process, when the protection target part is routed, the protection target part is passed through a gap between two electric wire routing pins disposed along a routing path for the protection target part on the jig plate, and
at the first outer layer installing process and the second outer layer installing process, when the exterior member is installed in each of the first outer layer installing process and the second outer layer installing process, the electric wire routing pins are inserted into mesh through holes of the exterior member, with the electric wire routing pins being thicker than the through holes.

11. The method for manufacturing a wire harness according to claim 3, wherein
at the inner layer installing process, when the protection target part is routed, the protection target part is passed through a gap between two electric wire routing pins disposed along a routing path for the protection target part on the jig plate, and
at the first outer layer installing process and the second outer layer installing process, when the exterior member is installed in each of the first outer layer installing process and the second outer layer installing process, the electric wire routing pins are inserted into mesh through holes of the exterior member, with the electric wire routing pins being thicker than the through holes.

12. The method for manufacturing a wire harness according to claim 4, wherein
at the inner layer installing process, when the protection target part is routed, the protection target part is passed through a gap between two electric wire routing pins disposed along a routing path for the protection target part on the jig plate, and
at the first outer layer installing process and the second outer layer installing process, when the exterior member is installed in each of the first outer layer installing process and the second outer layer installing process, the electric wire routing pins are inserted into mesh through holes of the exterior member, with the electric wire routing pins being thicker than the through holes.
